(19) United States
(12) Patent Application Publication
(10) Pub. No.: US 2012/0222566 A1
(43) Pub. Date: Sep. 6, 2012

(54) PLATE MADE OF A THERMOPLASTIC MATERIAL HAVING IMPROVED OPTICAL PROPERTIES, METHOD FOR MANUFACTURING SUCH A PLATE, AND USE THEREOF

(75) Inventors: Thierry Meyer, Wihr-au-Val (FR); Edouard Schmidt-Morgenroth, Labaroche (FR); Yves Klinger, Muttersholtz (FR)

(73) Assignee: DS SMITH KAYSERSBERG, Kaysersberg (FR)

(21) Appl. No.: 13/499,494

(22) PCT Filed: Sep. 30, 2010
(86) PCT No.: PCT/EP10/64551

§ 371 Date: May 25, 2012

(30) Foreign Application Priority Data
Sep. 30, 2009 (FR) 0956788

(51) Int. Cl. B41N 1/24; B32B 27/28; C08L 23/14; C08L 23/12; C08K 5/17; B32B 3/30; B32B 27/32

(52) U.S. Cl. 101/127; 428/166; 524/528; 524/236; 101/395

(57) ABSTRACT

The present invention relates to a plate made of a thermoplastic material including two planar outer sheets and one thermoformed central sheet having bosses on at least one surface, which is bonded to both planar sheets, the plate incorporating a dyeing agent in a sufficient quantity so as to render the plate opaque. The plate is characterized in that the dyeing agent is incorporated into 80 to 100% of both planar outer sheets, wherein both outer sheets are opaque, and at most, incorporated into 20% of the thermoformed central sheet, wherein the center sheet is translucent. The plate of the invention can be used as a printing substrate.

The present invention relates to the field of sheets or plates in plastic material for applications where the optical characteristics are important, such as plates for receiving a printing, more particularly through screen printing or even a digital one, or aspect parts in the automotive field.

This invention relates more particularly to a foamed plate in a thermoplastic material, including a polyolefin made of two external layers connected by a central layer made of a thermoformed sheet with bosses under the form, for example, of cylinders distributed according to a regular network pattern, for example, hexagonal. The particular conformation of the central layer imparts to the whole its mechanical properties, such as the load resistance as well as its functional characteristics. A method for manufacturing such a plate, referred to as a bubble structure, is described in patent WO 2005/105436.

Within the scope of the screen printing and digital printing, the following media are used:
expanded PVC plates having this advantage of having a smooth aspect, a very good opacity as well as a fire resistance. However, they have the main drawbacks of being highly expensive and having quite a high density mass and a sensitivity to scratching.
Double wall expanded polypropylene plates obtained by extrusion through a specific die followed by a calibration. A pair or a plurality of parallel planar walls are connected with each other by longitudinal struts, forming cells in the lengthwise direction with the wall. The advantages of such plates are a low density, a high rigidity in the direction of the struts as well as a significantly lower cost than that of PVC. The main drawback of such a product is related to shrink marks at the junction of the strut and of the upper and lower layers. Such shrink marks give a surface with some roughness. On the one hand, when the printed plate is placed before a light source (for example in the case of hanging posters), the vertical struts are visible through transparency, resulting in an adverse line effect to the printing rendering.
Solid polypropylene plates having the advantage of a homogeneous aspect and a good printability and the drawback of a lower rigidity than a foamed plate with an equivalent surface mass.
Plates of the above mentioned bubble structure type, made in polypropylene and described in the patent application FR 08161121.2, being able to advantageously replace the expanded PVC supports due to a good compromise between the rigidity and opacity properties and a weight gain of 30 to 50% compared to PVC.

The main drawback of such latter plates lies in that the central layer can be visible in transparency when the plate is placed before a light source, although the latter comprises an a priori sufficient amount of an opacifier. It has also been observed that the bubbles could, on a materiel described in patent application FR 08161121.2, be emphasized through an optical effect upon a digital printing or a screen printing since the applied ink layer was sufficiently thin. Such phenomena are mainly observed in the case of low surface masses where the thickness of the planar walls is quite low.

It should be noticed that the opacifier rate in the plate does not solve the problem; results are limited by the low thickness of the external layers and furthermore an excessive rate makes it brittle and has a deleterious effect on the extrusion. Moreover, the cost of such agents is high.

The present invention aims at overcoming such optical problems in the so-called bubble plates both in the printing field as well generally in the field of plates wherein a colouring agent has been incorporated.

Such a problem can be overcome with, in accordance with this invention, a plate made in a thermoplastic material comprising two external planar sheets and a central thermoformed sheet with bosses on at least one side, connected to the two planar sheets, the plate incorporating a colouring agent in a sufficient amount for making it opaque, characterized in that the colouring agent is incorporated at 80 to 100% into the two external planar sheets, said two sheets being opaque and at the most for 20% in the central thermoformed sheet, the central sheet being translucent.

By distributing the colouring agent so as to make the central layer invisible, a plate is obtained with an aspect similar to that of an homogeneous solid plate while maintaining both its mechanical properties, with a significant higher rigidity at an equivalent surface mass, and a good impact resistance due to the damping effect of the internal structure and with a low density, being lower than 0.4 g/cm³.

In the case of printing, using such a translucent or even transparent material in the internal layer removes perceiving bubbles through light transmission as well as the aspect problems after printing with no need to require the use of such particular opacifiers.

The colouring agent is the titanium dioxide (TiO₂); it also has an opacifying effect. Such an effect can be amplified through adding some aluminium powder. More particularly, the plate comprises from 2 to 5% TiO₂.

In accordance with another characteristic, the plate made in a thermoplastic material comprises a stiffening agent, such as talc.

This invention advantageously relates to a polyolefin based thermoplastic material, including polypropylene. More particularly, the thermoplastic material comprises from 30 to 90% of a polypropylene copolymer, preferably 40-80% of a polypropylene copolymer, and 50% of a polypropylene homopolymer. The polypropylene copolymer could be a block copolymer or a statistical copolymer.

The substance of the plate of this invention ranges between 150 g/m² and 4000 g/m², preferably between 400 g/m² and 2000 g/m² and more particularly, between 450 g/m² and 900 g/m². The plate has a thickness ranging between 1 and 12 mm, preferably between 2 and 10 mm. The bosses are cylindrical or in the shape of a dome, more specifically with a circular, oval or polygonal section. They have a diameter ranging between 3 and 18 mm, preferably between 4 and 14 mm.

This invention also relates to a method for manufacturing a plate. It is characterized in that the external sheets are formed through extruding an extrusion mixture comprising:

from 30 to 90% of a polypropylene copolymer having a melt flow index at 230° C.—2.16 kg ranging between 1 and 12 g/10 min, preferably 40-80% of a polypropylene copolymer having a melt flow index ranging between 3 and 8 g/10 min,

from 0 to 50% of a polypropylene homopolymer having a melt flow index at 230° C.—2.16 kg ranging between 1 and 12 g/10 min, preferably 5-30% of a polypropylene homopolymer having a melt flow index ranging between 3 and 8 g/10 min,

from 1 to 10% of a master batch containing a colouring agent,

from 5 to 30% of a master batch containing a stiffening agent,

from 0 to 5% of an anti UV master batch,

from 0 to 20% of a fireproof master batch, preferably from 2 to 15%, containing from 40 to 90% of active substances, preferably from 60 to 80%.

The extrusion mixture preferably comprises:

from 5 to 30% of a master batch containing a stiffening agent with 40-80% talc and 0-20% calcium carbonate, preferably from 5 to 20% of a master batch with 50-80% talc and 0-10% calcium carbonate,

from 1 to 10% of a white colouring master batch with 50-80% titanium dioxide, preferably from 2 to 6% of a white colouring master batch containing 60 to 75% titanium dioxide,

from 0 to 5% of an anti UV master batch containing 10-30% of a sterically hindered amine (HALS).

As far as the central layer is concerned, the latter is formed through extruding an extrusion mixture comprising:

from 30 to 100% of a polypropylene copolymer having a melt flow index at 230° C.—2.16 kg ranging between 1 and 12 g/10 min, preferably 60-90% of a polypropylene copolymer having a melt flow index ranging between 3 and 8 g/10 min,

from 0 to 70% of a polypropylene homopolymer having a melt flow index at 230° C.—2.16 kg ranging between 1 and 12 g/10 min, preferably 5-50% of a polypropylene homopolymer having a melt flow index ranging between 3 and 8 g/10 min,

from 0 to 20% of a master batch comprising 40-80% talc and 0-20% calcium carbonate, preferably from 5 to 10% of a master batch comprising 50-80% talc and 0-10% calcium carbonate,

from 0 to 20% of a fireproof master batch, preferably from 2 to 15%, containing from 40 to 90% of active substances, preferably from 60 to 80%.

The aim of the present application also encompasses using a plate as a screen or digital printing medium plate or even as a so-called aspect plate in the automotive field.

Other advantages and characteristics are set forth with the following description of the plate and the method according to the invention referring to a single appended FIGURE showing an example of a bubble structure sheet.

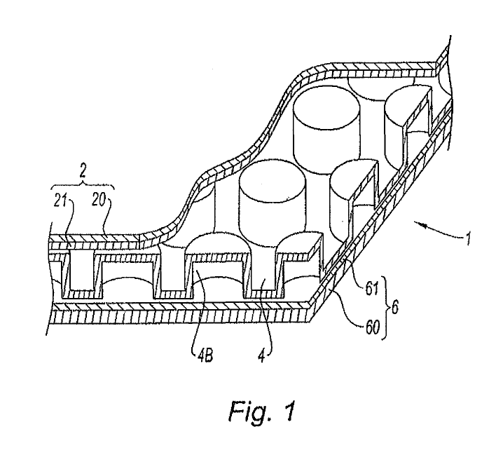

The sheet structure or bubble plate on FIG. 1 is made of three layers 2, 4, 6, i.e. a central layer 4 being sandwiched between two external covering layers 2 and 6, a layer 6 here on the FIGURE being lower 6 and an upper layer. The latter are planar and connected by a side to the central layer. The layer 4 is embossed and has bosses 4B according to a repeated, preferably regular, pattern. The layers are shown as having the same thickness, but they could be different. The bosses are here right cylindrical with a section being parallel to the lower layer and being circular, oval or other. The bosses are hexagonally distributed on the layer 4, the number thereof varying as a function of the diameter thereof. For example, the boss density per m² ranges between 30,000 and 40,000 for cylindrical bosses of 4 mm diameter and between 10,000 and 20,000 for bosses of 8 mm diameter. The height of the bosses is variable and depends on the diameter thereof, the height reaching for example 2.6 mm for a 4 mm diameter and 4.5 mm for a 8 mm diameter. According to other not shown embodiments, the bosses are frustoconical or shaped as a dome.

Preferably, the central layer 4 has bosses 4B extending on one single side, but the central layer could be differently embossed according to a symmetrical pattern for example.

The lower layer 6 is made of a layer 60 connected to the central layer by an appropriate binder 61. Such a binder could be a thermal activation material.

The upper layer 2 is made of a layer 20 connected to the central layer via the top of the bosses 4B thereof by an appropriate binder 21. As for the lower layer, such a binder may be a thermal activation material. In this example, the layer 4 is simple, but it could also comprise a layer 40 being coated with binder layers; the latter take part in the connexion with the upper and lower layers.

A manufacturing method adapted for producing the bubble plate is described in the patent application WO 2005/105436. The thermoplastic material mixture for each of the sheets is extruded through extrusion heads supplying three films. Immediately downstream the extrusion heads, the films are calendered between calendering cylinders so as to calibrate the thickness thereof and to provide a desired state of the external surfaces. The method then comprises overall the calendering steps of the three films. One of the films is thermoformed on an embossing cylinder having reliefs corresponding to the bosses to be obtained. The three layers are then assembled by welding so as to form the plate. A coextruded binder on each of the layers allows welding to be performed without softening the film structure.

The thus manufactured plates are characterized for the contemplated applications:
by a weight per m² ranging between 150 g/m² and 4000 kg/m², preferably, between 400 and 2000 g/m² and more particularly between 450 and 900 g/m²,
by a thickness ranging between 1 and 20 mm and preferably, from 2.0 to 10 mm,
by a bubble diameter ranging from 3 to 18 mm and preferably from 4 to 14 mm,
a density lower than 0.4 g/cm³.

In accordance with this invention, the colouring agent, here an opacifier, has been distributed between the two external layers, whereas the central layer does not comprise any.

In accordance with a preferred embodiment for an application as a printing plate, the composition of the extrusion material mixtures of the external layers contains:

from 30 to 90% of a polypropylene copolymer having a melt flow index at 230° C.—2.16 kg ranging between 1 and 12 g/10 min, preferably 40-80% of a polypropylene copolymer having a melt flow index ranging between 3 and 8 g/10 min,

from 0 to 70% of a polypropylene homopolymer having a melt flow index at 230° C.—2.16 kg ranging between 1 and 12 g/10 min, preferably 5-50% of a polypropylene homopolymer having a melt flow index ranging between 3 and 8 g/10 min,

from 5 to 30% of a master batch comprising 40-80% talc and 0-20% calcium carbonate, preferably, from 5 to 20% of a master batch comprising 50-80% talc and 0-10% calcium carbonate,

from 1 to 10% of a white colouring master batch containing 50-80% titanium dioxide, preferably from 2 to 6% of a white colouring master batch containing from 60 to 75% titanium dioxide,

from 0 to 5% of an anti UV master batch containing 10-30% of a sterically hindered amine (HALS), preferably, from 0 to 5% of an anti UV master batch containing 10-30% of a sterically hindered amine (HALS),

from 0 to 20% of a fireproof master batch, preferably from 2 to 15%, containing from 40 to 90% of active substances, preferably from 60 to 80%.

The composition of the extrusion material for the central layer contains:

from 30 to 100% of a polypropylene copolymer having a melt flow index at 230° C.—2.16 kg ranging between 1 and 12 g/10 min, preferably 60-90% of a polypropylene copolymer having a melt flow index ranging between 3 and 8 g/10 min,

from 0 to 70% of a polypropylene homopolymer having a melt flow index at 230° C.—2.16 kg, preferably 5-50% of a polypropylene homopolymer having a melt flow index ranging between 3 and 8 g/10 min, from 0 to 20% of a master batch comprising 40-80% talc and 0-20% calcium carbonate, preferably from 5 to 10% of a master batch comprising 50-80% talc and 0-10% calcium carbonate,

from 0 to 20% of a fireproof master batch, preferably from 2 to 15%, containing from 40 to 90% of active substances, preferably from 60 to 80%.

The distribution of the different layers depends on the material flow rate.

The material flow rate of the upper layer amounts to 20 to 50% of the total flow rate, preferably 30-45%.

The material flow rate of the central layer accounts for 15 to 50% of the total flow rate, preferably 20-40%.

The material flow rate of the lower layer accounts for 20 to 50% of the total flow rate, preferably 30-45%.

The layers are welded together by means of a coextruded binder made of a polypropylene terpolymer having a melt flow index at 230° C.—2.16 kg ranging between 1 and 15 g/10 min, preferably between 3 and 10 g/10 min.

Two plates were produced according to this invention.

### EXAMPLE 1

A plate having a mass per m² of 600 g
Bubble diameter of 4 mm

### Composition of the External Layers

65% of a PP block copolymer (melt flow index=3.5 g/10 min)
10% of a PP homopolymer (melt flow index=5 g/10 min)
20% of a master batch comprising 60% talc
5% of a white master batch comprising 75% titanium dioxide

### Composition of the Central Layer

100% of a PP block copolymer (melt flow index=3.5 g/10 min)

### Distribution of the Layers in Weight

Upper layer/central layer/lower layer=38/22/40

### EXAMPLE 2

A plate having a mass per m² of 900 g
Bubble diameter of 4 mm

### Composition of the External Layers

62% of a PP block copolymer (melt flow index=3.5 g/10 min)
10% of a PP homopolymer (melt flow index=5 g/10 min)
20% of a master batch comprising 60% talc,
6% of a white master batch comprising 60% titanium dioxide
2% of an anti UV master batch containing 20% HALS.

### Composition of the Central Layer

100% of a PP block copolymer (melt flow index=3.5 g/10 min)

### Distribution of the Layers in Weight

Upper layer/central layer/lower layer=36/22/42

### Properties

The properties of the two above described plates have been measured and compared to those of prior art plates: a standard bubble plate, a double wall foamed plate and a solid plate.

Measurements of the light transmission according to DIN 5036-ASTM D 1003-61 norm

| | EXAM- | Standard | Double wall | |
|---|---|---|---|---|
| | PLE 1 | bubble plate | plate | Solid plate |
| Thickness | 2.6 | 2.6 | 3.5 | 0.6 |
| (mm) | | | | |
| Mass per | 600 | 600 | 600 | 590 |
| m² (g) | | | | |
| Density | 0.23 | 0.23 | 0.17 | 0.88 |
| (g/cm³) | | | | |
| Composition | | PP Copo 70.3 | PP Copo 56.7 | PP Copo 94 |
| (%) | | PP Homo 10 | PP Homo 20 | MM colouring |
| | | PP + Talc 16.4 | PP + Talc 20 | agent 6 |
| | | MM colouring | MM colouring | |
| | | agent 3.3 | agent 3.3 | |
| | | Distribution: | | |
| | | 36/30/34 | | |
| Overall rate | 2.9 | 2.5 | 2.5 | 4.5 |
| of white | | | | |
| pigment | | | | |
| (titanium | | | | |
| dioxide) (%) | | | | |
| Overall rate | 9.4 | 9.8 | 12.0 | 0 |
| of mineral | | | | |
| filler | | | | |
| (Talc) (%) | | | | |
| Light | 5.8 | 7.2 | 10.3 | 6.6 |
| transmission | | | | |
| (%) | | | | |

| | | Standard | |
|---|---|---|---|
| | EXAMPLE 2 | bubble plate | Solid plate |
| Thickness (mm) | 3.0 | 3.2 | 1.0 |
| Mass per m² (g) | 900 | 900 | 960 |
| Density (g/cm³) | 0.30 | 0.28 | 0.96 |
| Composition | | PP Copo 70.3 | PP Copo 95 |
| | | PP Homo 10.0 | MM Colouring |
| | | PP + Talc 10.0 | agent 5 |
| | | MM Colouring | |
| | | agent 6.0 | |
| | | Distribution: | |
| | | 38/27/35 | |
| Overall rate of white | 2.8 | 3.6 | 3.0 |
| pigment (titanium | | | |
| dioxide) (%) | | | |
| Overall rate of | 9.4 | 6.0 | 0 |
| mineral filler (Talc) | | | |
| (%) | | | |
| Light transmission (%) | 1.6 | 2.4 | 4.7 |

There is obtained an opacity being higher than that of the other products while having an equivalent, or even lower, rate of colouring agent.

Measurement of the rigidity according to ISO 178 norm(*)

| | EXAMPLE | Solid | EXAMPLE | Solid |
|---|---|---|---|---|
| | 1 | plate | 2 | plate |
| Thickness (mm) | 2.6 | 0.6 | 3.0 | 1.0 |
| Mass per m² (g) | 600 | 590 | 900 | 960 |
| Density (g/cm³) | 0.23 | 0.98 | 0.30 | 0.96 |
| Bending | 1.75 | 0.04 | 3.50 | 0.21 |
| rigidity (N/mm) | | | | |
| Bending break | 7.4 | 0.75 | 26.1 | 4.3 |
| (N) | | | | |

(*): Dimensions of the test tubes: 150*40 mm, distance between supports: 100 mm, test velocity: 5 mm/min (rigidity) and 300 mm/min (break).

### Impact Resistance

Test: Determination of the breaking height upon a cylindrical spear drop (diameter 16 mm-mass: 370 g) on a sample arranged on a cylindrical support (diameter 220 mm, height 100 mm).

| | | Standard | Double |
|---|---|---|---|
| | EXEMPLE 1 | bubble plate | wall plate |
| Thickness (mm) | 2.6 | 3.2 | 3.5 |
| Mass per m² (g) | 600 | 900 | 600 |
| Density (g/cm³) | 0.23 | 0.28 | 0.17 |
| Breaking height at | 110 | 60 | 50 |
| 23° C. (cm) | | | |

1. A thermoplastic plate comprising:
two external planar sheets, and
a central thermoformed sheet with bosses on at least one side, connected to the two external planar sheets,
wherein the plate comprises a coloring agent incorporated at a rate of 80 to 100% into the two external planar sheets, the two external planar sheets being opaque, and at most 20% in the central thermoformed sheet, the central thermoformed sheet being translucent.

2. The thermoplastic plate of claim 1, wherein the coloring agent is TiO₂, optionally with aluminium, wherein the coloring agent has an opacifying effect.

3. The thermoplastic plate of claim 2, comprising 2 to 5% TiO₂.

4. The thermoplastic plate of claim 1, further comprising a stiffening agent.

5. The thermoplastic plate of claim 1, comprising a polyolefin.

6. The thermoplastic plate of claim 5, comprising from 30 to 90% of a polypropylene copolymer, and 50% of a polypropylene homopolymer.

7. The thermoplastic plate of claim 1, having an areal density of 400 g/m² to 2000 g/m².

8. The thermoplastic plate of claim 1, having a volumetric density less than 0.4 g/cm³.

9. The thermoplastic plate of claim 1, wherein the bosses have a cylindrical shape or a dome shape.

10. A method for manufacturing the thermoplastic plate of claim 1, comprising forming the external planar sheets by extruding an extrusion mixture comprising:
30 to 90% of a polypropylene copolymer having a melt flow index at 230° C.—2.16 kg of 1 to 12 g/10 min,
0 to 70% of a polypropylene homopolymer having a melt flow index at 230° C.—2.16 kg of 1 to 12 g/10 min,
1 to 10% of a master batch comprising a coloring agent,
5 to 30% of a master batch comprising a stiffening agent,
0 to 5% of an anti UV master batch,
0 to 20% of a fireproof master batch.

11. The method of claim 10, wherein the extrusion mixture comprises:
5 to 30% of a master batch comprising a stiffening agent, the stiffening agent comprising 40-80% talc and 0-20% calcium carbonate,
1 to 10% of a white coloring master batch comprising 50-80% titanium dioxide,
0 to 5% of an anti UV master batch comprising 10-30% of a sterically hindered amine.

12. The method of claim 10, further comprising forming the central thermoformed sheet extruding a second extrusion mixture comprising:
30 to 100% of a polypropylene copolymer having a melt flow index at 230° C.—2.16 kg of 1 to 12 g/10 min,
0 to 70% of a polypropylene homopolymer having a melt flow index at 230° C.—2.16 kg of 1 to 12 g/10 min,
0 to 20% of a master batch comprising 40-80% talc and 0-20% calcium carbonate.

13. A screen printing plate comprising the thermoplastic plate of claim 1.

14. An automotive aspect plate comprising the thermoplastic plate of claim 1.

15. A digital printing medium plate comprising the thermoplastic plate of claim 1.

16. The thermoplastic plate of claim 4, wherein the stiffening agent is talc.

17. The thermoplastic plate of claim 5, comprising 40 to 80% of a polypropylene copolymer and 50% of a polypropylene homopolymer.

18. The thermoplastic plate of claim 1, having an areal density of 450 g/m² to 900 g/m².

19. The thermoplastic plate of claim 9, wherein the bosses have a circular, oval, or polygonal cross section.

20. A method for manufacturing the thermoplastic plate of claim 1, comprising forming the external planar sheets by extruding an extrusion mixture comprising:
40 to 80% of a polypropylene copolymer having a melt flow index at 230° C.—2.16 kg of 3 to 8 g/10 min,
5 to 50% of a polypropylene homopolymer having a melt flow index at 230° C.—2.16 kg of 3 to 8 g/10 min,
1 to 10% of a master batch comprising a coloring agent,
5 to 30% of a master batch comprising a stiffening agent,
0 to 5% of an anti UV master batch,
0 to 20% of a fireproof master batch.
